(19) United States
(12) Patent Application Publication
(10) Pub. No.: US 2012/0274445 A1
(43) Pub. Date: Nov. 1, 2012

(54) AGGREGATING LOCATION WITH PRESENCE INFORMATION

(75) Inventors: Angela Chin, Redmond, WA (US); Jose Carlos Rios Furia, Seattle, WA (US); Divya Jindal, Kirkland, WA (US)

(73) Assignee: Microsoft Corporation, Redmond, WA (US)

(21) Appl. No.: 13/094,850

(22) Filed: Apr. 27, 2011

(51) Int. Cl. G08B 5/22

(52) U.S. Cl. 340/8.1

(57) ABSTRACT

Technologies are described herein for aggregating location information with presence information for a user and making the combined information available to other users. Location and presence information is received from various endpoints and communication services utilized by a particular user. The location and presence information is aggregated and a current location and presence for the user is determined The current location and presence may be stored in a presence document corresponding to the user. The presence document is made available to client applications executing on the endpoints of other users, so that the client applications may display the presence information combined with the current location of the user to the other users.

### BACKGROUND

A personal information management (“PIM”) client application, such as MICROSOFT® OUTLOOK® from MICROSOFT CORPORATION of Redmond, Washington, operating in conjunction with various server applications, may provide information regarding a contact's “presence,” such as whether the contact is on a call, available to speak, online, and the like. A user of the PIM application may utilize the contact's presence information to determine an appropriate mode of communication with the contact. For example, if the presence information for a contact indicates the contact is available to speak, the user may call the contact on the telephone. However, if the presence information indicates the contact is on a call, the user may choose to send the contact an e-mail message.

Although current presence information may let the user know which of their colleagues and contacts are available, users need additional information to help them decide who to contact and which modes of communication should be used for the contact. Location information is sometimes shared, but usually in the form of a static text string, such as an office location, that doesn't give the user any information about a contact's current location in relation to their own. In addition, users may not have the means to determine which of their colleagues and contacts are both available to communicate and located in proximity to them when choosing the appropriate contact with which to communicate.

It is with respect to these considerations and others that the disclosure made herein is presented.

### SUMMARY

Technologies are described herein for aggregating location information with presence information for a user and making the combined information available to other users. Utilizing the technologies described herein, a user of a PIM or other client application may view a contact's current location in the context of the contact's presence information in order to make a more informed decision on the best means to communicate with the contact. In addition, the client application may display multiple contacts along with each of the contacts' presence information and current location in relation to that of the user, such as on a map display, allowing the user to choose the most appropriate contact with which to communicate.

According to embodiments, a presence information aggregation service receives location and presence information from the various endpoints and communication services utilized by a particular user. The location and presence information is aggregated by the presence information aggregation service and a current location and presence for the user is determined The current location and presence may be stored in a presence document corresponding to the user. The presence information aggregation service makes the presence document available to client applications executing on the endpoints of other users, so that the client applications may display the presence information combined with the current location of the user to the other users.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and several software components provided by the embodiments presented herein;

FIG. 2 is a screen diagram showing an exemplary user interface for displaying location information combined with presence information regarding a user, according to embodiments described herein;

FIG. 3 is a flow diagram showing methods for aggregating location information with presence information for a user and making the combined information available to other users, according to embodiments described herein; and

FIG. 4 is a block diagram showing an illustrative computer hardware and software architecture for a computing system capable of implementing aspects of the embodiments presented herein.

### DETAILED DESCRIPTION

The following detailed description is directed to technologies for aggregating location information with presence information for a user and making the combined information available to other users. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

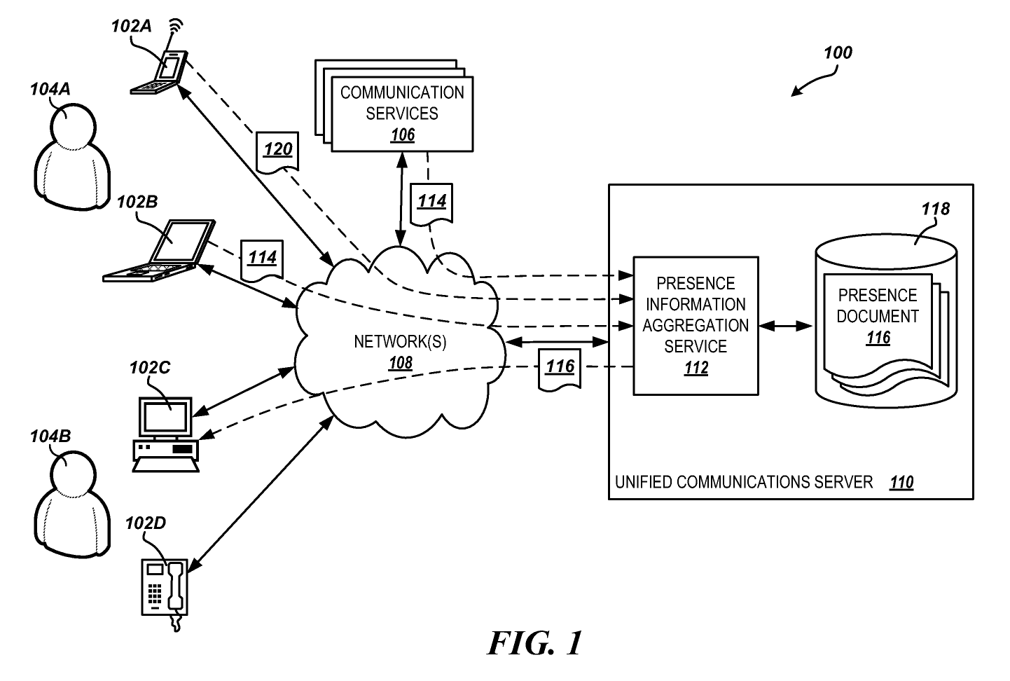

FIG. 1 shows an illustrative operating environment 100 including several software components for aggregating location information with presence information for a user and making the combined information available to other users, according to embodiments provided herein. The environment 100 may include a number of endpoints 102A-102D (referred to herein generally as endpoints 102) utilized by a number of users 104A-104B (referred to herein generally as users 104) to connect to and consume communications services 106 over one or more network(s) 108. The endpoints 102 may represent any type of computing devices and/or communication devices utilized by the users 104 to consume the communication services 106, including desktop personal computers (“PCs”), laptops, notebooks, personal digital assistants (“PDAs”), mobile phones, game consoles, set-top boxes, e-readers, Voice-over-IP (“VoIP”) phones, consumer electronics devices, and the like.

The communication services 106 may include all services accessible by the endpoints 102 over the network(s) 108, including e-mail services, Internet messaging (“IM”) services, Web and video conferencing services, VoIP services, contact management services, Web servers, Public Switched Telephone Network (“PSTN”) switches, and the like. According to embodiments, some of the communication services 106 may be provided by one more integrated server computers connected to the network(s) 108, while other of the communication services may be provided by non-integrated or remote servers, computing devices, telephonic devices, and other systems. The network(s) 108 support the various communication methods required by the different endpoints 102 with the various communication services 106. For example, the network(s) 108 may include local-area networks (“LANs”), wide-area networks (“WANs”), the Internet, the PSTN, cellular telephone networks, or any other networking topology that connects the endpoints 102 to the communication services 106.

According to embodiments, the environment also includes a unified communications server 110. The unified communications server 110 may provide one or more of the communication services 106 to the user's endpoints 102 over the network(s) 108. The unified communications server 110 may represent an integrated platform that provides users 104 with a range of communications from a variety of endpoints 102. For example, the unified communications server 110 may be the MICROSOFT® LYNC SERVER™ application from MICROSOFT CORPORATION or Redmond, Wash., the IBM® LOTUS® DOMINO® collaboration software from INTERNATIONAL BUSINESS MACHINES CORP. of Armonk, N.Y., or any other conferencing, communication, and collaboration server platform or technologies. The unified communications server 110 may be implemented on one or more conventional server computers, network appliances, special-purpose computing devices, other computing devices capable of executing application programs, or any combination thereof

A presence information aggregation service 112 executes on the unified communications server 110, according to embodiments. The presence information aggregation service 112 collects and aggregates presence information 114 regarding the users 104. The presence information 114 may include information regarding the current status of the user 104, such as whether the user is busy or free, engaged in a phone call, attending a meeting, out of the office, and the like. The presence information aggregation service 112 may execute on the unified communications server 110, or the presence information aggregation service may be implemented on one or more server computers, network appliances, and/or special-purpose computing devices connected to the unified communications server by the network(s) 108. The presence information aggregation service 112 may be implemented as software, hardware, or any combination of the two.

The presence information 114 may be reported to the presence information aggregation service 112 by client application(s) executing on one or more endpoints 102 of the user and/or by one or more of the communication services 106 with which the user interacts. Examples of presence information 114 reported by the endpoints 102 and/or communication services 106 and collected by the presence information aggregation service 112 include:

Information from a user's calendar reported by a communication service 106, such as an e-mail server, indicating that the user is scheduled to be in a meeting;

Information from a user's preferences reported by the e-mail server indicating the user's office hours or out-of-office status;

Information reported by a communication service 106, such as a Web conferencing server, that the user 104 is engaged in a conference;

Information reported by a communication service 106, such as a VoIP server, indicating that the user 104 is on the phone;

Information reported by an IM client application executing on a user's endpoint, such as the laptop endpoint 102B shown in FIG. 1, indicating the user 104 is logged into IM;

Information reported by a client application executing on a user's endpoint, such as the mobile phone endpoint 102A shown in FIG. 1, indicating that the user 104 is “mobile;” and the like.

It will be appreciated that the examples provided above are for illustration only and that other presence information 114 regarding a user 104 may be reported by the various endpoints 102 and/or communication services 106 utilized by the user and collected by the presence information aggregation service 112 beyond those described herein.

The presence information aggregation service 112 may aggregate and analyze the collected presence information 114 to determine a current status or “presence” of each user 104 and store the determined presence in a presence document 116 corresponding to the user. The presence documents 116 may be stored in a database 118 or other storage mechanism available to the unified communications sever 110, for example. The presence information aggregation service 112 may then make the information in the presence documents 116 available to other users 104 on the various endpoints 102 utilized by those users. For example, the presence information aggregation service 112 may collect and aggregate presence information 114 reported by an endpoint 102B of user 104A, store the aggregated presence information in a presence document 116 corresponding to user 104A on the unified communications server 110, and make the presence document 116 corresponding to user 104A available to user 104B through endpoint 102C over the network(s) 108. It will further be appreciated that access to the presence documents 116 for a user 104 by other users and endpoints may be controlled through access-control lists, such as “buddy” lists, group permissions, or other appropriate information access security mechanisms.

According to further embodiments, the presence information aggregation service 112 also collects location information 120 regarding some or all of the users 104 from the various endpoints 102 and/or communication services 106. The form and content of the location information 120 may depend on the reporting endpoint 102 or communication service 106. For example, dynamic location information 120 in the form of geographic coordinates may be reported by a client application executing on a mobile phone endpoint 102A with a GPS receiver or a laptop endpoint 102B connected through a location-aware wireless access point. In addition, the client applications executing on these portable endpoints 102A, 102B may periodically update the location information 120 when the application senses the location of the endpoint changes.

Static location information 120 in the form of an address, room number, etc. may be reported by a communication service 106 utilized by a user 104 through a fixed endpoint, such as a computer endpoint 102C or a VoIP phone endpoint 102D connected to a wired network, by corresponding a MAC or IP address of the fixed endpoint with a known location of the computer. Other sources of location information 120 may be imagined by one skilled in the art beyond those described herein, and it is intended that all such sources of location information 120 be included in this application. In one embodiment, the presence information aggregation service 112 may receive multiple location information 120 regarding a user 104 from different endpoints 102, and may utilize additional information, such as a determination of the most active endpoint, to determine a current location for that user.

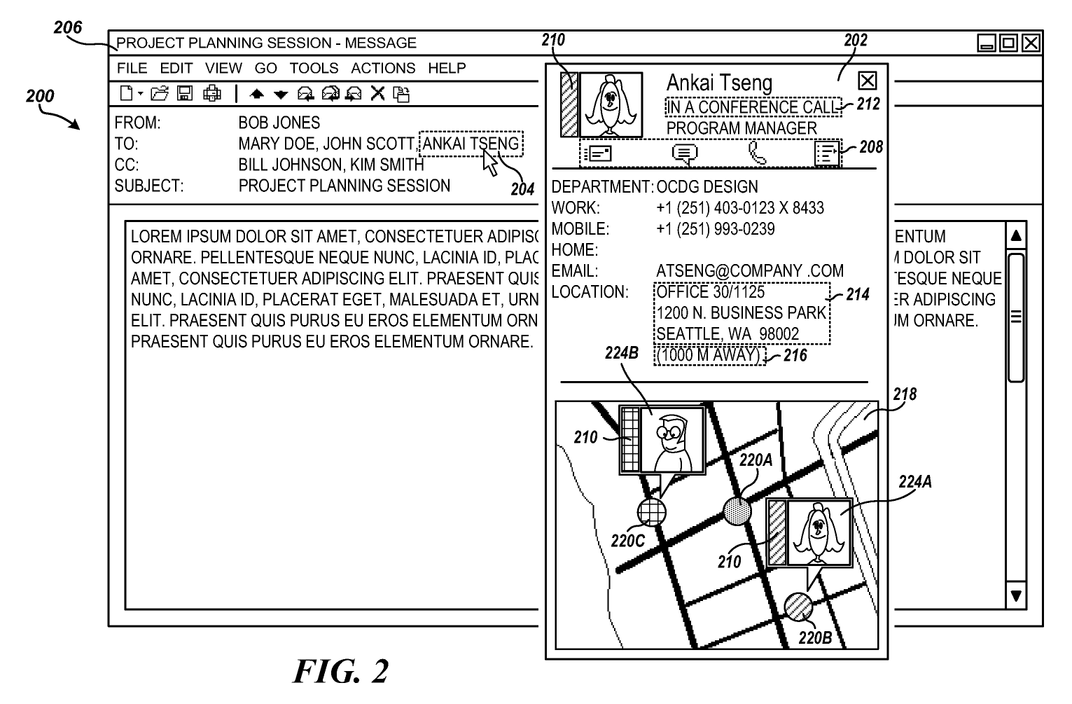

The presence information aggregation service 112 may then aggregate the collected location information 120 with the presence information 114 for the user 104 and store the current location with the user's current presence in the corresponding presence document 116. The current location stored in the presence document 116 may consist of any combination of geographic coordinates, a street address, a floor, a room number, and the like. The presence information aggregation service 112 may then make the presence document 116 with the current location regarding one user, such as user 104A, available to other users, such as user 104B, as described above. According to one embodiment, a client application executing on an endpoint of user 104B, such as endpoint 102C, may receive the aggregated presence information 114 and location information 120 in the presence document 116 corresponding to user 104A, and display the combined information to user 104B, as will be described below in regard to FIG. 2.

FIG. 2 is a screen diagram illustrating a user interface (“UI”) 200 generated by a client application executing on a user's endpoint 102 for displaying location information 120 combined with presence information 114, according to embodiments. The UI 200 may be displayed to a viewing user, such as user 104B, by a client application executing on an endpoint, such as endpoint 102C, upon receiving the presence document 116 in conjunction with other contact information corresponding to a user of interest, such as user 104A, for example.

The UI 200 includes a contact card 202 showing aggregated information regarding the user of interest 104A. The contact card 202 may be shown by the client application in the UI 200 in response to the viewing user 104B selecting an identifier 204 of the user of interest 104A within a window 206 of the client application, for example. The contact card 202 may include a picture of the user of interest 104A, the user's name, title, department, office, contact information, and the like, as shown in FIG. 2. According to one embodiment, the contact card 202 may further include contact UI controls 208 that allow the viewing user 104B to contact the user of interest 104A in various ways, such as via e-mail, IM, telephone, and the like.

In addition, the contact card 202 includes indications of the current presence information 114 for the user of interest 104A from the received presence document 116 corresponding to the user. For example, the contact card 202 may include a graphical presence indicator 210 that indicates aspects of the current presence information 114 for the user. The graphical presence indicator 210 may be a combination of colors, attributes, and graphics icons that relates the presence information 114, such as a green block for available, a red block for busy, a gray block for unknown status, and the like. The contact card may further include a presence description 212 that provides a textual description of the current presence information 114 for the user, such as “AVAILABLE,” “IN A MEETING,” “IN A CONFERENCE CALL,” “ON THE PHONE,” “OUT OF THE OFFICE,” and the like.

As described herein, the viewing user 104B may utilize the graphical presence indicator 210 and/or the presence description 212 to decide how to contact the user of interest 104A. For example, if the graphical presence indicator 210 and/or the presence description 212 indicate that the user of interest 104A is available, then the viewing user 104B may initiate a phone call to the user of interest. The viewing user 204B may utilize the contact UI controls 208 on the contact card 202 to initiate the call to the user of interest 204A. If the graphical presence indicator 210 and/or the presence description 212 indicate that the user of interest 104A is on a phone call, the viewing user 104B may choose to send an e-mail message to the user of interest, again using the contact UI controls 208 on the contact card 202, for example. However, the presence information 114 indicated in the graphical presence indicator 210 and/or the presence description 212 alone may not provide the viewing user 104B all the information required to determine the best method of communicating with the user of interest 104A, as will become apparent below.

According to one embodiment, the contact card 202 further includes indications of the current location information 120 for the user of interest 104A from the received presence document 116 corresponding to the user. For example, the contact card 202 may include a current location description 214 for the user showing a textual description of the user's current location determined from the aggregated location information 120. The current location description 214 may include a street address, office location, floor, room number, and the like relating the current location of the user.

In addition, the contact card 202 may include a relative position indicator 216 that indicates the current location of the user of interest 104A in relation to the current location of the viewing user 104B. For example, the client application may utilize the current location information 120 in the received presence document 116 to calculate the distance between the current location of the user of interest 104A and that of the viewing user 104B, and display the calculated distance in the relative position indicator 216, as shown in FIG. 2.

Additionally or alternatively, the contact card 202 may include a map display 218 showing the relative locations of the viewing user 104B, the user of interest 104A, and/or other users on a geographical map. The map display 218 may include a street map, a building or floor map, or any other geographic or spatial map. The map display 218 may include a position indicator 220A (referred to herein generally as position indicator 220) showing the current location of the viewing user 104B on the map, and a position indicator 220B indicating the relative location of the user of interest 104A on the map, as determined from the current location information 120 received in the presence document 116.

The map display 218 may also include position indicators, such as position indicator 220C, for other users related to the viewing user 104B or user of interest 104A. For example, the map display 218 may include a position indicator 220C showing the location of the user's administrative assistant, shadow, supervisor, or other individuals that may be able to facilitate communication with or for the user of interest 104A. According to another embodiment, the map display 218 may include additional position indicators 220 for other users 104 as well, such as users within the same group or organization of and within proximity to the viewing user 104B, users in the viewing user's contact or “buddy” lists, other users related to the e-mail message being viewed in the windows 206 of the PIM client application program, and the like. The current location of the other users 104 may be determined by retrieving a presence document 116 corresponding to each user from the presence information aggregation service 112, for example.

In one embodiment, the position indicators 220 may further relate the current presence information 114 of the corresponding user from the retrieved presence document 116. For example, the position indicator 220B for the user of interest 104A may be displayed with the same color and/or attributes as the graphical presence indicator 210 shown on the contact card 202 for the user. In addition, digest information 224A, 224B regarding a user 104 may be displayed in the map display 218 in proximity to the position indicator 220B, 220C corresponding to the user. The digest information 224A, 224B may show presence information 114 and/or contact information regarding a user 104 in conjunction with the user's relative location on the map. For example, the digest information 224A shown for the user of interest 104A may include a picture of the user, as shown in FIG. 2, along with the graphical presence indicator 210 for the user from the presence document 116 corresponding to the user. The digest information 224A, 224B for a user 104 may be shown when the viewing user 104B selects the corresponding position indicator 220B, 220C on the map display 218, by hovering a mouse pointer over the position indicator, for example.

It will be appreciated that other displays of combined location information 120 and presence information 114 for one or more users 104 may be imagined beyond those described herein, including list views, map views, contact card views, and the like. For example, search results for a user search performed by the client application may combine indications of current presence information 114 and current location information 120 for each user retrieved from the presence information aggregation service 112, along with a relative position of each user in relation to the searching user 104, shown in a list and/or a map display 218. Similarly, a viewing user 104B may be able to display their contact list or “buddy” list with indications of current presence information 114, current location information 120, and relative position of each user in a list and/or map display 218, in a manner similar to that described above.

Using the combined current presence information 114 and location information 120 provided by the presence information aggregation service 112 in the presence document 116, a viewing user 104B may be able to make a more informed decision regarding the most appropriate method of communication with the user of interest 104A or other users. For example, if the graphical presence indicator 210 and/or the presence description 212 indicate that the user of interest 104A is available and the current location description 214, the relative position indicator 216, and/or the position indicator 220A in the map display 218 indicate the user is just down the hall or down two floors in the same building, the viewing user 104B may choose a face-to-face conversation with the user of interest instead of a phone call. Similarly, while the graphical presence indicator 210 and/or the presence description 212 indicate that the user of interest 104A is available and in the office, the position indicator 220A in the map display 218 for the user may indicate that she is down the street at a coffee shop, warranting a phone call instead of a face to face conversation. Alternatively, the graphical presence indicator 210 displayed in the digest information 224B in conjunction with a position indicator 220C corresponding to a different user 104 in the map display 218 may prompt the viewing user 104B to contact the alternative user instead of the original user of interest 104A.

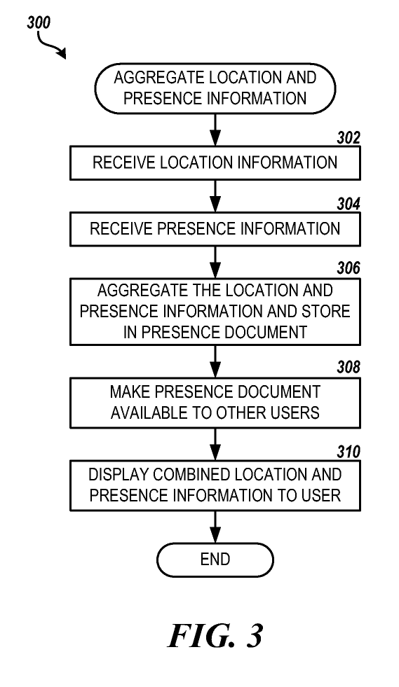

Referring now to FIG. 3, additional details will be provided regarding the embodiments presented herein. It should be appreciated that the logical operations described with respect to FIG. 3 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof It should also be appreciated that more or fewer operations may be performed than shown in the figures and described herein. The operations may also be performed in a different order than described.

FIG. 3 illustrates a routine 300 for aggregating location information with presence information for a user and making the combined information available to other users, according to embodiments described herein. According to one embodiment, the routine 300 is performed by the presence information aggregation service 112 executing on the unified communications server 110 and/or other servers or computing devices. It will be appreciated that the routine 300 may also be performed by other modules or components executing on other computing devices, or by any combination of modules, components, and computing devices.

The routine 300 begins at operation 302, where the presence information aggregation service 112 receives current location information 120 regarding a user 104A. As described above in regard to FIG. 1, the presence information aggregation service 112 collects the location information 120 from various endpoints 102 and/or communication services 106 utilized by the user 104A. The form and content of the location information 120 may depend on the reporting endpoint 102 or communication service 106, and may include static location information or dynamic location information with periodic updates. The location information 120 may include one or more of a set of geographic coordinates, a street address, a floor, a room number, and the like. In one embodiment, the presence information aggregation service 112 may receive multiple location information 120 regarding the user 104A from different endpoints 102, and may use additional information, such as a determination of the most active endpoint, to determine a current location for that user.

From operation 302, the routine 300 proceeds to operation 304, where the presence information aggregation service 112 receives presence information 114 regarding the user 104A. As further described above, the presence information aggregation service 112 collects presence information 114 reported by client application(s) executing on one or more endpoints 102 of the user and/or by one or more of the communication services 106 with which the user interacts. The presence information 114 may include information regarding the current status of the user 104A, such as whether the user is busy or free, engaged in a phone call, attending a meeting, out of the office, and the like.

The routine 300 proceeds from operation 304 to operation 306, where the presence information aggregation service 112 aggregates the received presence information 114 and location information 120 to determine a current presence and current location for the user 104A. In one embodiment, the aggregation of the received presence information 114 and location information 120 may include resolving inconsistencies between the two. For example, a communication service 106, such as an e-mail server, may report that the user 104A is logged-in on a computing endpoint 102C in the user's office, indicating that the user as “IN THE OFFICE.” At the same time, the presence information aggregation service 112 may receive location information 120 from a mobile phone endpoint 102A of the user 104A that indicates that the user is in a coffee shop down the street. The presence information aggregation service 112 may utilize other information, such as a determination of the most active or last active endpoint 102, to determine a current location and/or presence for that user 104A. For example, in the example above, the presence information aggregation service 112 may determine that the current location for the user 104A is in the coffee shop and the current presence is some combination of “AVAILABLE” and ‘OUT OF THE OFFICE.” The presence information aggregation service 112 may then store the determined current presence and location in the presence document 116 corresponding to the user 104A in the database 118 or other storage mechanism available to the unified communications sever 110.

From operation 306, the routine 300 proceeds to operation 308, where the presence information aggregation service 112 makes the presence document 116 containing the combined presence information 114 and location information 120 corresponding to the user 104A available to other users, such as user 104B. For example, the presence information aggregation service 112 may publish the updated presence document 116 corresponding to the user 104A to endpoints 102 executing client applications that have subscribed to presence information regarding the user. Alternatively or additionally, the presence information aggregation service 112 may support queries by client applications executing on endpoints 102 to retrieve presence document(s) 116 related to one or more users 104, based on specified e-mail addresses, user IDs, or other identifiers of the desired users. It will be appreciated that the presence information aggregation service 112 may make the presence document 116 regarding the user 104A available to other users in any number of ways known it the art beyond those described herein, such as through a website accessible by the other users.

The routine 300 proceeds from operation 308 to operation 310, where the combined current presence information 114 and location information 120 for the user 104A is displayed to the other users. For example, a client application executing on a computing endpoint 102C for a viewing user 104B may retrieve the presence document 116 for the user 104A from the presence information aggregation service 112, and display the presence information 114 and location information 120 contained therein to the viewing user 104B through a UI 200 that includes one or more of the a graphical presence indicator 210, a presence description 212, a current location description 214, a relative position indicator 216, or a map display 218, such as that described above in regard to FIG. 2. From operation 310, the routine 300 ends.

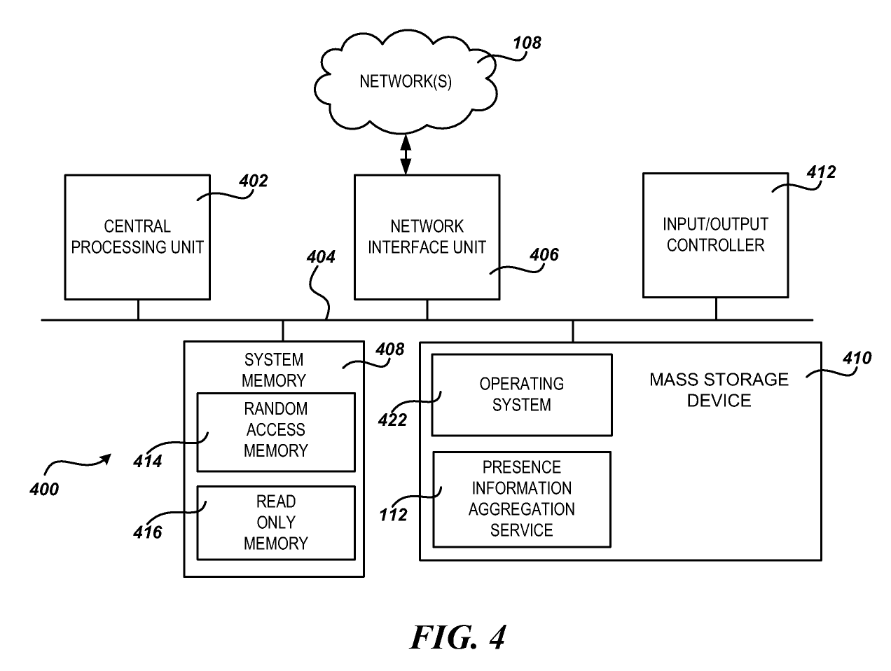

FIG. 4 shows an example computer architecture for a computer 400 capable of executing the software components described herein for aggregating location information with presence information for a user and making the combined information available to other users, in the manner presented above. The computer architecture shown in FIG. 4 illustrates a conventional server computer, desktop computer, laptop, notebook, PDA, wireless phone, or other computing device, and may be utilized to execute any aspects of the software components presented herein described as executing on the unified communications server 110, endpoint 102, or other computing device.

The computer architecture shown in FIG. 4 includes one or more central processing units (“CPUs”) 402. The CPUs 402 may be standard processors that perform the arithmetic and logical operations necessary for the operation of the computer 400. The CPUs 402 perform the necessary operations by transitioning from one discrete, physical state to the next through the manipulation of switching elements that differentiating between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 408, including a random access memory (“RAM”) 414 and a read-only memory 416 (“ROM”), and a system bus 404 that couples the memory to the CPUs 402. A basic input/output system containing the basic routines that help to transfer information between elements within the computer 400, such as during startup, may be stored in the ROM 416. The computer 400 also includes a mass storage device 410 for storing system programs, application programs, program modules, data files, and other information, which are described in greater detail herein.

The mass storage device 410 is connected to the CPUs 402 through a mass storage controller (not shown) connected to the bus 404. The mass storage device 410 provides non-volatile storage for the computer 400. The computer 400 may store information on the mass storage device 410 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 400 may store information to the mass storage device 410 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 400 may further read information from the mass storage device 410 by detecting the physical states or characteristics of one or more particular locations within the mass storage device.

As mentioned briefly above, a number of system programs, application programs, and data files may be stored in the mass storage device 410 and RAM 414 of the computer 400, including an operating system 422 suitable for controlling the operation of a computer. The mass storage device 410 and RAM 414 may also store one or more program modules. In particular, the mass storage device 410 and the RAM 414 may store the presence information aggregation service 112, which was described in detail above in regard to FIG. 1. The mass storage device 410 and the RAM 414 may also store other types of program modules or data.

In addition to the mass storage device 410 described above, the computer 400 may have access to other computer-readable media to store and retrieve information, such as program modules, data structures, or other data. It should be appreciated by those skilled in the art that computer-readable media may be any available media that can be accessed by the computer 400, including computer-readable storage media and communications media. Communications media includes transitory signals. Computer-readable storage media includes volatile and non-volatile, removable and non-removable media implemented in any method or technology for the storage of information, such as computer-readable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 400.

The computer-readable storage medium may be encoded with computer-executable instructions that, when loaded into the computer 400, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 400 by specifying how the CPUs 402 transition between states, as described above. According to one embodiment, the computer 400 may have access to computer-readable storage media storing computer-executable instructions that, when executed by the computer, perform the routine 300 for aggregating location information with presence information for a user and making the combined information available to other users, described above in regard to FIG. 3.

According to various embodiments, the computer 400 may operate in a networked environment using logical connections to remote computing devices and computer systems through one or more network(s) 108, such as a LAN, a WAN, the Internet, or a network of any topology known in the art. The computer 400 may connect to the network(s) 108 through a network interface unit 406 connected to the bus 404. It should be appreciated that the network interface unit 406 may also be utilized to connect to other types of networks and remote computer systems.

The computer 400 may also include an input/output controller 412 for receiving and processing input from a number of input devices, including a keyboard, a mouse, a touchpad, a touch screen, an electronic stylus, or other type of input device. Similarly, the input/output controller 412 may provide output to a display device, such as a computer monitor, a flat-panel display, a digital projector, a printer, a plotter, or other type of output device. It will be appreciated that the computer 400 may not include all of the components shown in FIG. 4, may include other components that are not explicitly shown in FIG. 4, or may utilize an architecture completely different than that shown in FIG. 4.

Based on the foregoing, it should be appreciated that technologies for aggregating location information with presence information for a user and making the combined information available to other users are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for aggregating presence information and location information regarding a first user, the method comprising executing instructions in one or more computer systems to perform the operations of:
receive the presence information comprising a status of the first user;
receive the location information comprising a location of the first user;
combine the presence information and the location information to determine a current presence and a current location for the first user;
store the current presence and the current location in a presence document corresponding to the first user, wherein the presence document is made available to an endpoint of a second user;
receive the presence document at the endpoint; and
display the current presence of the first user combined with the current location of the first user to the second user, the display indicating a relative position of the first user with respect to a position of the second user.

2. The computer-implemented method of claim 1, wherein the display of the current presence and current location of the first user comprises a text-based indication of the current presence combined with a text-based indication of the current location.

3. The computer-implemented method of claim 2, wherein the relative position of the first user with respect to the position of the second user is indicated by a distance between the first user and the second user.

4. The computer-implemented method of claim 1, wherein the display of the current presence and current location of the first user comprises a map display indicating a position of the first user in relation to the second user.

5. The computer-implemented method of claim 4, wherein the map display further displays a current presence and a current location of a third user, the third user being related to the first user and/or the second user.

6. The computer-implemented method of claim 1, wherein the location information is received from a location-aware mobile endpoint of the first user.

7. A computer-readable storage medium encoded with computer-executable instructions that, when executed by a computer, cause the computer to:
aggregate location information and presence information regarding a first user;
store the aggregated location information and presence information in a presence document corresponding to the first user; and
make the presence document available to a client application executing on an endpoint of a second user, wherein the aggregated location information and presence information are displayed together to the second user.

8. The computer-readable storage medium of claim 7, wherein the presence information is received by the computer from a communication service utilized by the first user.

9. The computer-readable storage medium of claim 7, wherein the location information is received by the computer from a location-aware mobile endpoint of the first user.

10. The computer-readable storage medium of claim 7, wherein the client application displays a text-based indication of a current presence of the first user, a text-based indication of a current location of the first user, and a text-based indication of a relative position of the first user with respect to a position of the second user.

11. The computer-readable storage medium of claim 10, wherein the text-based indication of the relative position of the first user with respect to the position of the second user comprises a distance between the first user and the second user.

12. The computer-readable storage medium of claim 7, wherein the client application displays a map display indicating a position of the first user in relation to the second user.

13. The computer-readable storage medium of claim 12, wherein the map display further comprises an indication of the presence information regarding the first user in proximity to the position of the first user in the map display.

14. The computer-readable storage medium of claim 12, wherein the map display further comprises an indication of a position of a third user in relation to the second user, and an indication of presence information regarding the third user in proximity to the position of the third user in the map display.

15. The computer-readable storage medium of claim 7, wherein making the presence document available to the client application comprises providing the presence document to the client application in response to a query indicating an identifier of the first user.

16. A system comprising:
a first client application executing on a first endpoint and configured to report location information regarding a first user;
a communication service configured to report presence information regarding the first user;
a presence information aggregation service configured to aggregate the reported location information and presence information and make the aggregated location information and presence information available to a second client application; and
the second client application configured to display the aggregated presence information and location information to a second user.

17. The system of claim 16, wherein the second client application is further configured to display a text-based indication of a current presence of the first user, a text-based indication of a current location of the first user, and a text-based indication of a relative position of the first user with respect to a position of the second user.

18. The system of claim 16, wherein the second client application is further configured to display a map display indicating a position of the first user in relation to the second user.

19. The system of claim 18, wherein the second client application is further configured to display an indication of the presence information regarding the first user in proximity to the position of the first user on the map display.

20. The system of claim 18, wherein the second client application is further configured to display an indication of a position of a third user in relation to the second user on the map display and an indication of presence information regarding the third user in proximity to the position of the third user on the map display.
